(19) United States
(12) Patent Application Publication
(10) Pub. No.: US 2004/0153906 A1
(43) Pub. Date: Aug. 5, 2004

(54) Microcomputer

(75) Inventors: Masayoshi Kusumoto, Kawasaki (JP); Tetsuya Yoshida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/715,595

(22) Filed: Nov. 19, 2003

(30) Foreign Application Priority Data
Dec. 26, 2002 (JP) 2002-378628

(51) Int. Cl. G06F 12/00

(52) U.S. Cl. 714/710

(57) ABSTRACT

An interrupt vector is stored in a bank B of a dual operation flash memory, and an alternate interrupt vector corresponding to the interrupt vector is stored in a bank A. During rewrite processing of the bank B, if a CPU accesses the interrupt vector, an interrupt vector address conversion circuit converts the address of the interrupt vector to the address of the alternate interrupt vector, to access the memory. As a result, the interrupt vector data can be obtained to start the interrupt processing.

### CROSS-REFERENCE TO RELATED APPLICATIONS

This application is based upon and claims the benefit of priority from the prior Japanese Patent Application No.2002-378628, filed on Dec. 26, 2002, the entire contents of which are incorporated herein by reference.

### BACKGROUND OF THE INVENTION

1) Field of the Invention

The present invention relates to a one-chip microcomputer that executes interrupt processing during rewriting of a main program stored in a nonvolatile memory.

2) Description of the Related Art

A flash memory is one of rewritable nonvolatile memories, and a microcomputer having the flash memory built in becomes popular. In the apparatus installing this kind of microcomputer, a program for the microcomputer can be rewritten in a state that the microcomputer is installed. Therefore, a manufacturer can write a program in the microcomputer for each destination, immediately before shipment of the apparatus, or a user can easily update the program and data for the microcomputer after the shipment from the manufacturer.

Generally, if an interrupt vector is stored together with a main program in a built-in flash memory of the microcomputer, the interrupt vector cannot be read during rewrite processing of the main program, and hence interrupt processing cannot be executed. Instead, a software polling is used in a boot program for the rewrite processing.

In this case, since it is necessary to constantly read a flag indicating the hardware condition by loop processing or the like, the time for performing other processing becomes short, causing not only a problem of increasing degree of difficulty in a software development, but also a problem of limitation in degree of freedom in the processing. Further, there is another disadvantage of not being able to cope with a case when an interrupt of an exceptional event occurs.

To solve the problems, a microcomputer has been developed in which a value of the interrupt vector set in a program counter is directly changed to access a nonvolatile memory or an area that is not being an object of the rewrite to perform the interrupt processing during the rewrite processing. This type of conventional technology is disclosed in, for example, Japanese Patent Application Laid-open Publication No. 9-97176 and Japanese Patent Application Laid-open Publication No. 9-282181. In this microcomputer, even during the rewrite processing, a storage address of the interrupt vector is not changed.

Further, a data processing apparatus is has also been developed in which a memory is provided separately from the nonvolatile memory that stores the main program, and an alternate interrupt vector is stored in the separate memory, so that the alternate interrupt vector can be used during the rewrite processing. One of the data processing apparatus is disclosed in, for example, Japanese Patent Application Laid-open Publication No. 8-278895. In this data processing apparatus, the rewrite program in the nonvolatile memory is stored in a memory other than the nonvolatile memory.

According to the configuration disclosed in the above Patent Documents, acceptance of interrupt becomes possible. Therefore, since when the hardware condition changes, a change can be made at a time of changing a hardware condition, functions of a software can be considerably improved. Further, since the exceptional interrupt can also be handled, a malfunction can be prevented.

However, in the configuration disclosed in the first two Patent Documents, since an interrupt processing starting address is fixed, it cannot properly be changed according to the program capacity or the like. In the configuration disclosed in the third Patent Document, since a separate memory is necessary, construction of the apparatus becomes complicated, causing an increase in product cost.

A flash memory including two storage areas in which delete and write can be electrically performed independently (hereinafter, “dual operation flash memory”), and a microprocessor apparatus having the dual operation flash memory built-in has been developed. This type of microprocessor apparatus is disclosed in, for example, Japanese Patent Application Laid-open Publication No. 6-180999. Normally, when a built-in central processing unit rewrites the main program stored in the dual operation flash memory, a rewrite program stored in a storage area of the flash memory (hereinafter, “bank”), in which the main program is not stored, is executed.

However, even if the dual operation flash memory is built in as in the configuration disclosed in the fourth Patent Document, an interrupt vector stored in the same bank together with the main program cannot be read during the rewrite processing. Therefore, the interrupt processing cannot properly be performed.

### SUMMARY OF THE INVENTION

It is an object of the present invention to solve at least the problems in the conventional technology.

The microcomputer according to one aspect of the present invention includes a nonvolatile memory including at least a first storage area and a second storage area in which delete and write of data is electrically performed independently, a central processing unit that has a mechanism to access the nonvolatile memory, a flag indicating that the first storage area is not accessible, and a conversion circuit that, based on a state of the flag, converts an address indicating a storage place of the interrupt vector that is accessed by the central processing unit into an address indicating a storage place of the corresponding alternate interrupt vector. A plurality of interrupt vectors indicating respective storage places of a plurality of interrupt programs executed upon requesting of an interrupt is stored in the first storage area, and a plurality of alternate interrupt vectors corresponding to the respective interrupt vectors is stored in the second storage area.

The microcomputer according to another aspect of the present invention includes a nonvolatile memory including at least a first storage area and a second storage area in which delete and write of data is electrically performed independently, a central processing unit that has a mechanism to access the nonvolatile memory, a flag indicating that the first storage area is not accessible, and a conversion circuit that, based on a state of the flag, performs address conversion so that an area including the interrupt vector accessed by the central processing unit in the first storage area is replaced with an area including the corresponding alternate interrupt vector in the second storage area. A plurality of interrupt vectors indicating respective storage places of a plurality of interrupt programs executed upon requesting of an interrupt is stored in the first storage area, and a plurality of alternate interrupt vectors corresponding to the respective interrupt vectors is stored in the second storage area.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of an example of a main part of a microcomputer according to the present invention;

FIG. 2 is another example of program configuration in a nonvolatile memory in the microcomputer;

FIG. 3 is a third example of the program configuration in the nonvolatile memory in the microcomputer;

FIG. 4 is a fourth example of the program configuration in the nonvolatile memory in the microcomputer;

FIG. 5 is a fifth example of the program configuration in the nonvolatile memory in the microcomputer;

FIG. 6 is a sixth example of the program configuration in the nonvolatile memory in the microcomputer;

FIG. 7 is an example of an interrupt vector address conversion circuit in the microcomputer;

FIG. 8 is another example of an interrupt vector address conversion circuit in the microcomputer;

FIG. 9 is a third example of an interrupt vector address conversion circuit in the microcomputer; and

FIG. 10 is a fourth example of an interrupt vector address conversion circuit in the microcomputer.

### DETAILED DESCRIPTION

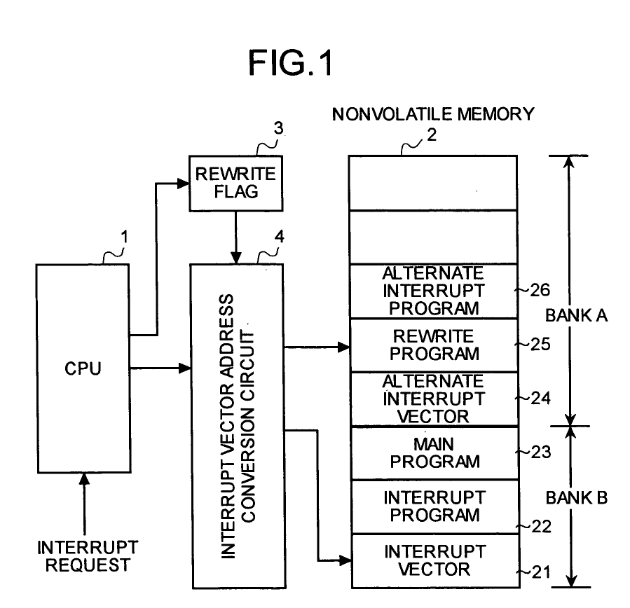

Exemplary embodiments of a microcomputer according to the present invention will be explained in detail with reference to the accompanying drawings. FIG. 1 is a block diagram of an example of a main part of a microcomputer according to the present invention. As shown in FIG. 1, the microcomputer includes a central processing unit (CPU) 1, a nonvolatile memory 2, a rewrite flag 3, and an interrupt vector address conversion circuit 4. These are formed on the same semiconductor chip.

Upon reception of an interrupt request, the CPU 1 generates a corresponding interrupt vector address. The nonvolatile memory 2 includes a dual operation flash memory. This dual operation flash memory is not particularly limited, but divided into a bank B, being a first storage area and a bank A, being a second storage area. The banks B and A have a configuration such that deletion and rewrite can be electrically performed independently.

For example, an interrupt vector 21, an interrupt program 22, and a main program 23 are stored in the bank B. On the other hand, an alternate interrupt vector 24 corresponding to the interrupt vector 21, a rewrite program 25, and an alternate interrupt program 26 corresponding to the interrupt program 22 are stored in the bank A.

The rewrite flag 3 is a flag indicating that the bank B cannot be accessed due to the rewrite processing, deletion processing, or write processing being executed with respect to a part or all of the bank B. The rewrite flag 3 is set by the CPU 1 at the time of starting the rewrite processing, deletion processing, or write processing.

When the rewrite flag 3 is set, that is, the bank B cannot be accessed, and when the CPU 1 accesses to the interrupt vector 21, the interrupt vector address conversion circuit 4 performs address conversion so that the CPU 1 accesses the alternate interrupt vector 24 instead of the interrupt vector 21. The interrupt vector address conversion circuit 4 does not perform address conversion, when the rewrite flag 3 is not set, that is, the bank B can be accessed.

In the configuration shown in FIG. 1, the interrupt vector 21 indicates the start address of the corresponding interrupt program 22. The alternate interrupt vector 24 indicates the start address of the corresponding alternate interrupt program 26. Therefore, when the bank B cannot be accessed, access to the interrupt program 22 stored in the bank B is also not possible. In this embodiment, however, the interrupt processing can be executed by accessing the alternate interrupt vector 24 to read the alternate interrupt program 26.

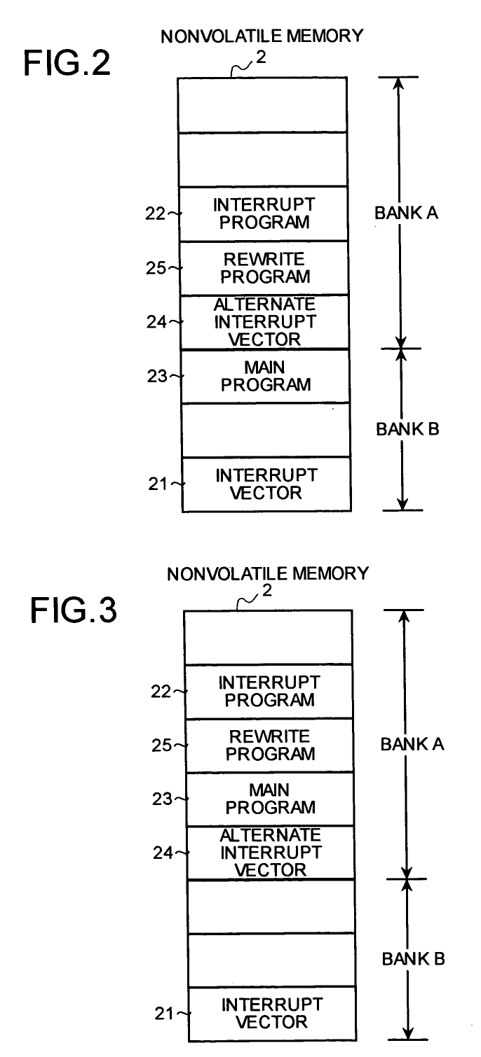

FIG. 2 is another example of program configuration in a nonvolatile memory in the microcomputer. The interrupt vector 21 and the main program 23 may be stored in the bank B, and the alternate interrupt vector 24, the rewrite program 25, and the interrupt program 22 may be stored in the bank A. In this case, the interrupt vector 21 and the alternate interrupt vector 24 both indicate the start address of the interrupt program 22.

FIG. 3 is a third example of the program configuration in the nonvolatile memory in the microcomputer. The interrupt vector 21 may be stored in the bank B, and the alternate interrupt vector 24, the main program 23, the rewrite program 25, and the interrupt program 22 may be stored in the bank A. Also in this case, the interrupt vector 21 and the alternate interrupt vector 24 both indicate the start address of the interrupt program 22.

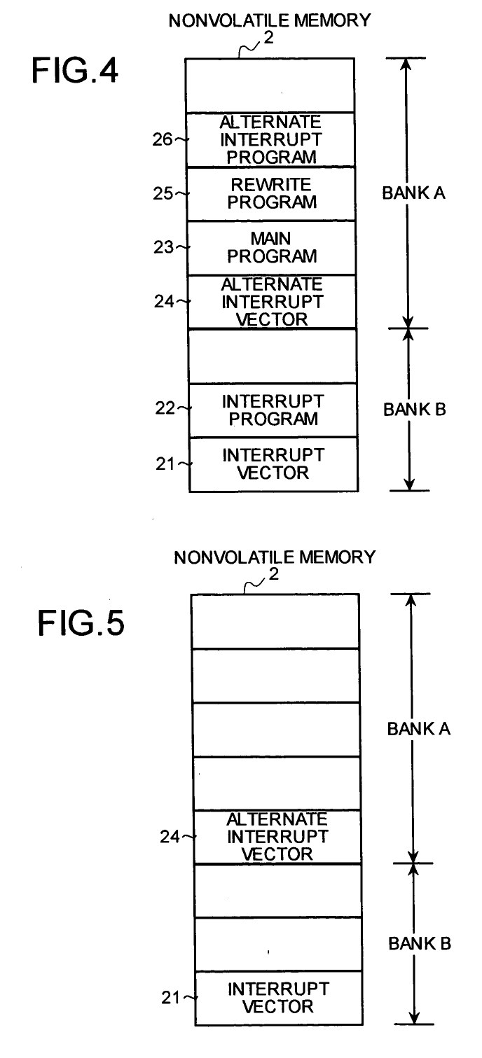

FIG. 4 is a fourth example of the program configuration in the nonvolatile memory in the microcomputer. The interrupt vector 21 and the interrupt program 22 may be stored in the bank B, and the alternate interrupt vector 24, the main program 23, the rewrite program 25, and the alternate interrupt program 26 may be stored in the bank A. In this case, the interrupt vector 21 and the alternate interrupt vector 24 respectively indicate the start address of the interrupt program 22, and the start address of the alternate interrupt program 26.

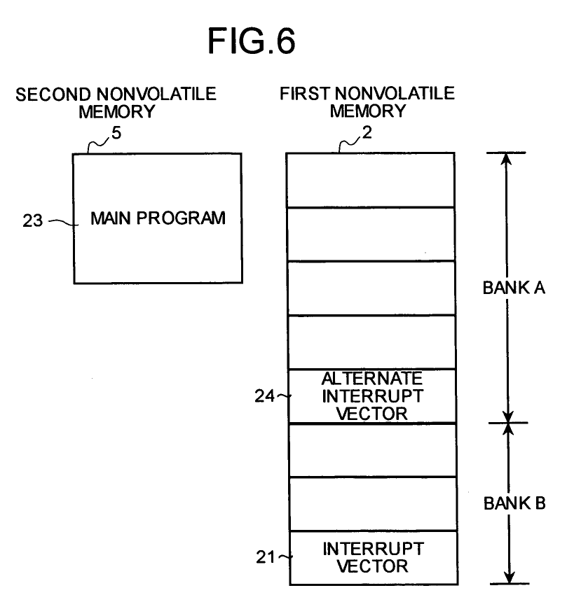

FIG. 5 is a fifth example of the program configuration in the nonvolatile memory in the microcomputer. The interrupt vector 21 may be stored in the bank B, and the alternate interrupt vector 24 may be stored in the bank A. In this case, the interrupt program 22, the main program 23, and the rewrite program 25 may be stored in a memory (not shown) other than the nonvolatile memory 2. In the example shown in FIG. 6, the main program 23 is stored in a second nonvolatile memory 5 separate from the nonvolatile memory 2.

When the nonvolatile memory 2 has another bank, at least one of the interrupt program 22, the main program 23, and the rewrite program 25 may be stored in the bank. When the storage area of the interrupt program 22 is other than the bank B, the interrupt vector 21 and the alternate interrupt vector 24 both indicate the start address of the interrupt program 22.

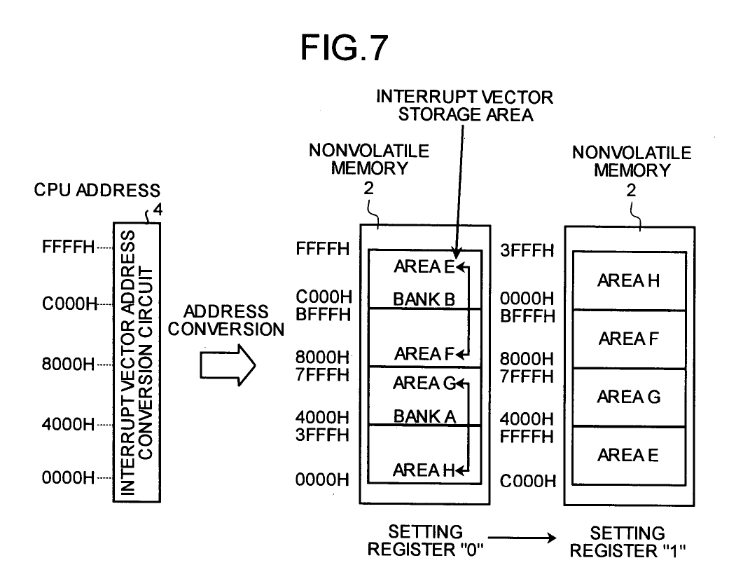

The configuration of the interrupt vector address conversion circuit 4 and the address conversion operation will be explained below. FIG. 7 conceptually illustrates a configuration of the interrupt vector address conversion circuit 4 and a first example of the address conversion operation. In the example shown in FIG. 7, a setting register is provided in the interrupt vector address conversion circuit 4, and for example, when a value of the setting register indicates “1”, an area E in the bank B (where the interrupt vector is stored) is replaced by an area H in the bank A by the address conversion operation. The alternate interrupt vector is stored in the area H.

When the value of the setting register indicates “0”, the interrupt vector address conversion circuit 4 does not perform the address conversion operation. The value of the setting register changes, for example, based on the write flag. The write flag may be directly used, without providing the setting register.

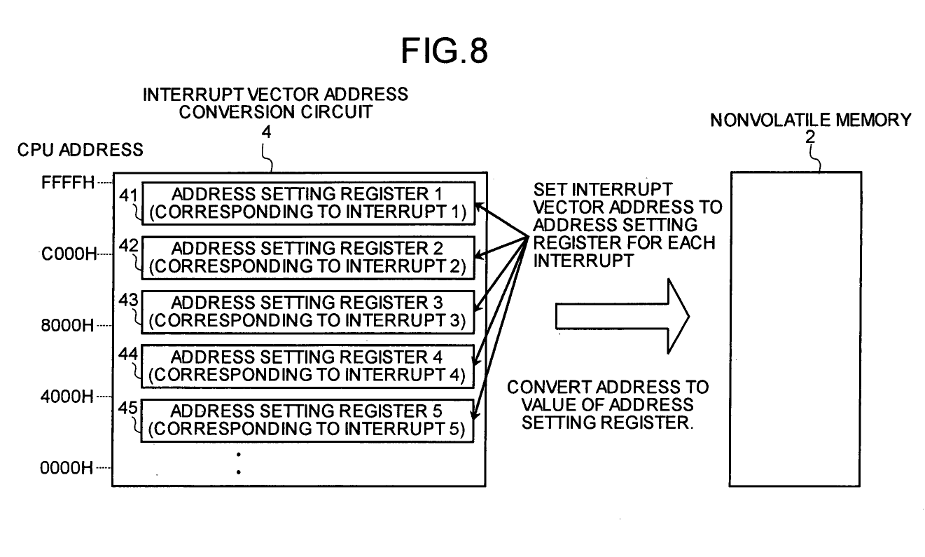

FIG. 8 conceptually illustrates the configuration of the interrupt vector address conversion circuit 4 and a second example of the address conversion operation. In the example shown in FIG. 8, a start address setting register 41, a second address setting register 42, a third address setting register 43, a fourth address setting register 44, a fifth address setting register 45, and the like are provided in the interrupt vector address conversion circuit 4, corresponding to a plurality of interrupts, respectively.

Converted addresses of the respective interrupt vector addresses, that is, addresses of the alternate interrupt vectors corresponding to the respective interrupt vectors are stored in the respective address setting registers 41, 42, and the like. When an access to the interrupt vector is not possible due to rewriting or the like, the interrupt vector address conversion circuit 4 outputs the address stored in the corresponding address setting register.

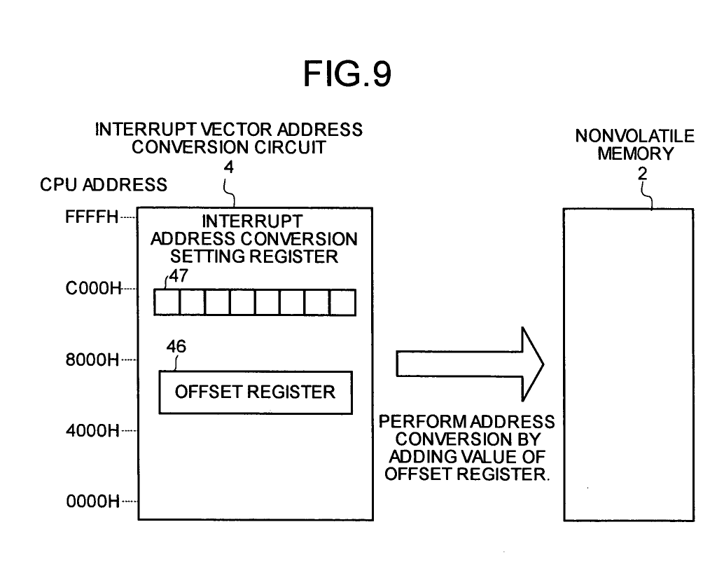

FIG. 9 conceptually illustrates the configuration of the interrupt vector address conversion circuit 4 and a third example of the address conversion operation. In the example shown in FIG. 9, an offset register 46 and an interrupt address conversion setting register 47 are provided in the interrupt vector address conversion circuit 4. A difference between the interrupt vector address and the alternate interrupt vector address, that is, an offset quantity therebetween is set in the offset register 46. The interrupt address conversion setting register 47 is set based on, for example, the write flag.

For example, when an access to the interrupt vector is not possible, the value of the interrupt address conversion setting register 47 becomes “1”. At this time, when the CPU accesses the interrupt vector, the interrupt vector address conversion circuit 4 outputs a value obtained by adding the offset quantity to the interrupt vector address. When the value of the interrupt address conversion setting register 47 is for example “0”, the interrupt vector address conversion circuit 4 directly outputs the interrupt vector address accessed by the CPU. The write flag may be directly used, without providing the interrupt address conversion setting register 47.

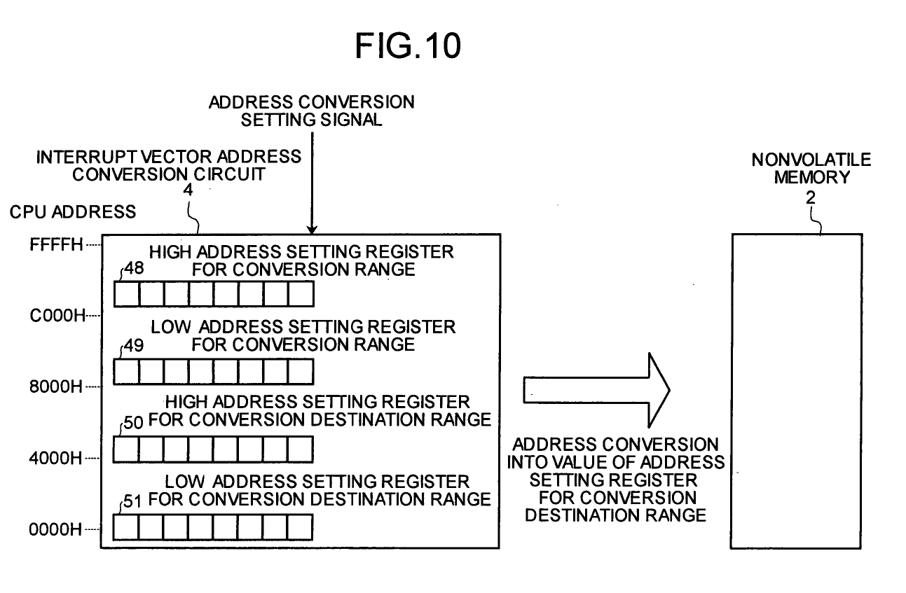

FIG. 10 conceptually illustrates the configuration of the interrupt vector address conversion circuit 4 and a fourth example of the address conversion operation. In the example shown in FIG. 10, a higher conversion range address setting register 48, a lower conversion range address setting register 49, a higher converted range address setting register 50, and a lower converted range address setting register 51 are provided in the interrupt vector address conversion circuit 4.

In the higher conversion range address setting register 48 and the lower conversion range address setting register 49, the top and the bottom values of the address range to be converted are respectively set. In the higher converted range address setting register 50 and the lower converted range address setting register 51, the top and the bottom values of the converted address range are respectively set.

When there is an access from the CPU to the address in the range determined by the set values of the higher conversion range address setting register 48 and the lower conversion range address setting register 49, the interrupt vector address conversion circuit 4 converts the address range to the address range set in the higher converted range address setting register 50 and the lower converted range address setting register 51, so that the CPU accesses the nonvolatile memory 27. Further, an address conversion setting signal based on the state of the write flag is supplied to the interrupt vector address conversion circuit 4. When the address conversion setting signal is for example “1”, the interrupt vector address conversion circuit 4 performs the address conversion operation, and when “0”, the interrupt vector address conversion circuit 4 allows the CPU access directly to the nonvolatile memory 42.

According to the exemplary embodiments, even when an access to the interrupt vector 21 is not possible due to the execution of the write processing or the like in the area storing the interrupt vector 21, the interrupt vector data can be read from the alternate interrupt vector 24 stored in an accessible area, by the address conversion by the interrupt vector address conversion circuit 4. As a result, even during a rewrite operation of the main program or the like, the interrupt processing can be performed.

According to the exemplary embodiments, the start address of the interrupt program 22 is indicated by the interrupt vector 21 stored in the nonvolatile memory 2, and when there is the alternate interrupt program 26, the start address of the alternate interrupt program 26 is indicated by the alternate interrupt vector 24 stored in the nonvolatile memory 2. Therefore, program developers can optionally set the respective start addresses of the interrupt program 22 and the alternate interrupt program 26, according to need.

According to the exemplary embodiments, when there are the interrupt vector 21, the interrupt program 22, the main program 23, the alternate interrupt vector 24, and the alternate interrupt program 26 in the same nonvolatile memory 2, the alternate interrupt program 26 can be stored. Therefore, it is not necessary to provide a memory for storing the alternate interrupt vector 24, the rewrite program 26, and the alternate interrupt program 26, separately from the nonvolatile memory 2 storing the main program.

The present invention is not limited to the embodiments, and can be changed variously. For example, the nonvolatile memory 2 is not limited to the dual operation flash memory, so long as the memory is divided into two or more storage areas in which deletion and write can be electrically performed independently. The nonvolatile memory 2 may be divided as a storage area in which deletion and write can be electrically performed independently, for each one byte.

The interrupt vector address conversion circuit 4 may include hardware that performs a predetermined conversion operation, or the configuration thereof may be realized by performing a predetermined conversion operation according to the setting performed by the software.

According to the present invention, even when the area storing the interrupt vector is not accessible, the interrupt vector data can be read from the alternate interrupt vector stored in an accessible area, by the address conversion by the interrupt vector address conversion circuit. As a result, even during a rewrite operation of the nonvolatile memory, the interrupt processing can be performed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A microcomputer comprising:
a nonvolatile memory including at least a first storage area and a second storage area in which delete and write of data is electrically performed independently, wherein
a plurality of interrupt vectors indicating respective storage places of a plurality of interrupt programs executed upon requesting of an interrupt is stored in the first storage area, and
a plurality of alternate interrupt vectors corresponding to the respective interrupt vectors is stored in the second storage area;
a central processing unit that has a mechanism to access the nonvolatile memory;
a flag indicating that the first storage area is not accessible; and
a conversion circuit that, based on a state of the flag, converts an address indicating a storage place of the interrupt vector that is accessed by the central processing unit into an address indicating a storage place of the corresponding alternate interrupt vector.

2. The microcomputer according to claim 1, wherein the conversion circuit includes a plurality of registers to which addresses indicating the respective storage places of the alternate interrupt vectors are set, and outputs an address that is set in the register corresponding to the interrupt vector address accessed by the central processing unit.

3. The microcomputer according to claim 1, wherein
the conversion circuit includes a register to which an offset quantity of the address indicating a storage place of the alternate interrupt vector corresponding to the address indicating the storage place of the interrupt vector is set, and
a value obtained by adding the offset quantity set in the register to the interrupt vector address accessed by the central processing unit is output from the conversion circuit.

4. The microcomputer according to claim 1, wherein the conversion circuit comprises hardware that performs a predetermined conversion operation.

5. The microcomputer according to claim 1, wherein the conversion circuit performs a predetermined conversion operation based on a setting by a software.

6. The microcomputer according to claim 1, wherein the nonvolatile memory, the central processing unit, the flag, and the interrupt vector address conversion circuit are integrated on a same semiconductor chip.

7. The microcomputer according to claim 1, wherein
the interrupt program is stored in the first storage area,
the interrupt vector stores a start address of the interrupt program,
the alternate interrupt program that is executed instead of the interrupt program is stored in the second storage area, and
the alternate interrupt vector stores a start address of the alternate interrupt program.

8. The microcomputer according to claim 1, wherein
the interrupt program is stored in the second storage area, and
the interrupt vector and the alternate interrupt vector store a start address of the interrupt program.

9. The microcomputer according to claim 7, wherein a main program is stored in the first storage area.

10. The microcomputer according to claim 8, wherein a main program is stored in the first storage area.

11. The microcomputer according to claim 7, wherein a main program is stored in the second storage area.

12. The microcomputer according to claim 8, wherein a main program is stored in the second storage area.

13. The microcomputer according to claim 7, wherein a main program is stored in a memory other than the nonvolatile memory.

14. The microcomputer according to claim 8, wherein a main program is stored in a memory other than the nonvolatile memory.

15. A microcomputer comprising:
a nonvolatile memory including at least a first storage area and a second storage area in which delete and write of data is electrically performed independently, wherein
a plurality of interrupt vectors indicating respective storage places of a plurality of interrupt programs executed upon requesting of an interrupt is stored in the first storage area, and
a plurality of alternate interrupt vectors corresponding to the respective interrupt vectors is stored in the second storage area;
a central processing unit that has a mechanism to access the nonvolatile memory;
a flag indicating that the first storage area is not accessible; and
a conversion circuit that, based on a state of the flag, performs address conversion so that an area including the interrupt vector accessed by the central processing unit in the first storage area is replaced with an area including the corresponding alternate interrupt vector in the second storage area.

16. The microcomputer according to claim 15, wherein the conversion circuit performs address conversion individually for a plurality of areas including each of the interrupt vectors.

17. The microcomputer according to claim 15, wherein the conversion circuit comprises hardware that performs a predetermined conversion operation.

18. The microcomputer according to claim 15, wherein the conversion circuit performs a predetermined conversion operation based on a setting by a software.

19. The microcomputer according to claim 15, wherein the nonvolatile memory, the central processing unit, the flag, and the interrupt vector address conversion circuit are integrated on a same semiconductor chip.

20. The microcomputer according to claim 15, wherein
the interrupt program is stored in the first storage area,
the interrupt vector stores a start address of the interrupt program,
the alternate interrupt program that is executed instead of the interrupt program is stored in the second storage area, and
the alternate interrupt vector stores a start address of the alternate interrupt program.

21. The microcomputer according to claim 15, wherein
the interrupt program is stored in the second storage area, and
the interrupt vector and the alternate interrupt vector store a start address of the interrupt program.

22. The microcomputer according to claim 20, wherein a main program is stored in the first storage area.

23. The microcomputer according to claim 21, wherein a main program is stored in the first storage area.

24. The microcomputer according to claim 20, wherein a main program is stored in the second storage area.

25. The microcomputer according to claim 21, wherein a main program is stored in the second storage area.

26. The microcomputer according to claim 20, wherein a main program is stored in a memory other than the nonvolatile memory.

27. The microcomputer according to claim 21, wherein a main program is stored in a memory other than the nonvolatile memory.
